(19) United States
(12) Patent Application Publication
(10) Pub. No.: US 2024/0242200 A1
(43) Pub. Date: Jul. 18, 2024

(54) SYSTEM AND METHOD FOR USING A BLOCKCHAIN TO ENABLE DECENTRALIZED STAKING POOL FUNDRAISING

(71) Applicant: CROWDSTAKE GLOBAL, INC., AUSTIN, TX (US)

(72) Inventor: James Jackson Leach, Cedar Creek, TX (US)

(21) Appl. No.: 18/411,784

(22) Filed: Jan. 12, 2024

Related U.S. Application Data
(60) Provisional application No. 63/439,001, filed on Jan. 13, 2023.

(51) Int. Cl. G06Q 20/36; G06Q 20/10; H04L 9/00

(52) U.S. Cl. CPC G06Q 20/36; G06Q 20/10; H04L 9/50

(57) ABSTRACT

In one embodiment, a computer-implemented method includes receiving, via a user interface, a selection of a smart project to join, wherein the smart project is controlled via a smart contract deployed on a blockchain. The method includes receiving an amount of cryptocurrency to pledge to the smart project for a set period of time based on the smart contract, transmitting, from a first digital wallet, the amount of cryptocurrency to an address associated with the smart project at a first block on the blockchain, receiving, based on the amount of cryptocurrency, an annual percentage yield, and transmitting, based on the smart contract, the annual percentage yield to a second block associated with a smart collateral digital wallet on the blockchain. The method includes determining when a trigger condition occurs, and responsive to the trigger condition occurring, returning the cryptocurrency to the first digital wallet.

### CROSS-REFERENCE TO RELATED APPLICATIONS

This application claims the benefit of and priority to U.S. Application Patent Ser. No. 63/439,001 filed Jan. 13, 2023, titled “SYSTEM AND METHOD FOR USING A BLOCKCHAIN TO ENABLE DECENTRALIZED STAKING POOL FUNDRAISING,” the entire disclosure of which is hereby incorporated by reference for all purposes.

### TECHNICAL FIELD

This disclosure relates generally to blockchain technology. More specifically, this disclosure relates to systems and methods for using blockchain technology to enable decentralized staking pool fundraising.

### BACKGROUND

A blockchain is a distributed database that maintains a continuously-growing list of records, called blocks, that may be linked together to form a chain. Each block in the blockchain may contain a timestamp and a link to a previous block and/or record. The blocks may be secured from tampering and revision. In addition, a blockchain may include a secure transaction ledger database shared by parties participating in an established, distributed network of computers. A blockchain may record a transaction (e.g., an exchange or transfer of information) that occurs in the network, thereby reducing or eliminating the need for trusted/centralized third parties. In some cases, the parties participating in a transaction may not know the identities of any other parties participating in the transaction but may securely exchange information. Further, the distributed ledger may correspond to a record of consensus with a cryptographic audit trail that is maintained and validated by a set of independent computers.

### SUMMARY

In general, the present disclosure provides systems and methods for using blockchain technology to enable decentralized staking pool fundraising.

In one embodiment, a computer-implemented method includes receiving, via a user interface, a selection of a smart project to join, wherein the smart project is controlled via a smart contract deployed on a blockchain. The method includes receiving an amount of cryptocurrency to pledge to the smart project for a set period of time based on the smart contract, transmitting, from a first digital wallet, the amount of cryptocurrency to an address associated with the smart project at a first block on the blockchain, receiving, based on the amount of cryptocurrency, an annual percentage yield, and transmitting, based on the smart contract, the annual percentage yield to a second block associated with a smart collateral digital wallet on the blockchain. The method includes determining when a trigger condition occurs, and responsive to the trigger condition occurring, returning the cryptocurrency to the first digital wallet.

In one embodiment, a method may include receiving, at a first node, a block in a blockchain and determining whether the block is located at a certain position within the blockchain. The method may also include, responsive to determining the block is located at the certain position within the blockchain, receiving, for a threshold period of time, indications from other nodes participating in the blockchain system. The method may also include obtaining an average number of the other nodes from which the indications are received for the threshold period of time, and determining, based on the average number of the other nodes, a number of nodes to which the first node is connected.

In one embodiment, a computer-implemented method may include deploying a smart contract to an address of a block on a blockchain, wherein the smart contract specifies one or more rules associated with a smart project. The method may include determining, via an oracle, when an annual percentage yield in a smart collateral digital wallet satisfies a target value amount.

The annual percentage yield may be generated based on staked cryptocurrency in a second digital wallet separate from the smart collateral digital wallet, and the staked cryptocurrency may be associated with the smart project. Responsive to determining the annual percentage yield in the smart collateral digital wallet satisfies the target value amount, the method may include performing one or more actions.

In another aspect, a system may include a memory device storing instructions and a processing device communicatively coupled to the memory device. The processing device may execute the instructions to perform one or more operations of any method disclosed herein.

In another aspect, a tangible, non-transitory computer-readable medium may store instructions and a processing device may execute the instructions to perform one or more operations of any method disclosed herein.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, independent of whether those elements are in physical contact with one another. The terms “transmit,” “receive,” and “communicate,” as well as derivatives thereof, encompass both direct and indirect communication. The terms “transmit,” “receive,” and “communicate,” as well as derivatives thereof, encompass both communication with remote systems and communication within a system, including reading and writing to different portions of a memory device. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable storage medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable storage medium” includes any type of medium capable of being accessed by a computer, such as read only memory (ROM), random access memory (RAM), a hard disk drive, a compact disc (CD), a digital video disc (DVD), solid state drive (SSD), or any other type of memory. A “non-transitory” computer readable storage medium excludes wired, wireless, optical, or other communication links that transport transitory electrical or other signals. A non-transitory computer readable storage medium includes media where data can be permanently stored and media where data can be stored and later overwritten, such as a rewritable optical disc or an erasable memory device.

The term “blockchain” may refer to a distributed database that maintains a continuously-growing list of records, called blocks, that may be linked together to form a chain.

The term “blockchain system” may refer to a group of nodes that cooperate to maintain and build a blockchain according to a protocol.

The term “node” may refer to a computing device participating in the blockchain system and that is connected to and interacts with the blockchain.

The term “hash” may refer to an output of a cryptographic function used in securing information in a blockchain.

The term “rehash” may refer to performing a hash function on data that has previously been hashed.

The term “genesis block” may refer to a starting block of a blockchain.

The term “data” may refer to information in digital form that may be transmitted and/or processed.

The term “transaction” may refer to any data that is processed through the blockchain.

The term “user” may refer to a person who uses a computing device.

The term “consensus algorithm” may refer to a process used to achieve approval or agreement on a single data value in a distributed system.

The term “feedback loop” may refer to a mutually dependent relationship between two parties in a given system.

The term “proof of work” may refer to a cryptographic process to ensure data security and/or uniformity.

The term “SHA” may refer to Secure Hash Algorithm.

The term “SHA-2” may refer to a set of cryptographic hash functions designed by the United States National Security Agency.

The term “SHA256” may refer to a member of the SHA-2 cryptographic hash functions and may generate an almost-unique 256-bit data signature.

The term “digital wallet” may refer to an application or online service used to make payments electronically or to store electronic tickets, cryptocurrency, documents, digital currency, etc. Digital wallets may contain digital versions of credit and debit cards that are stored in wallet applications on mobile devices (e.g., Apple Pay®, Samsung Pay, Google Pay, etc.). Digital wallets securely store payment information and/or monetary amounts of digital currency.

The term “oracle” may refer to an entity that connects a blockchain to one or more external systems, thereby enabling smart contracts to execute based upon inputs and outputs from the real world. Oracles provide a way for the decentralized Web3 ecosystem to access existing data sources, legacy systems, and advanced computations.

The term “staked cryptocurrency” may refer to a cryptocurrency that is committed to support a blockchain network or smart project and confirm transactions. Staking may refer to a way cryptocurrencies verify their transactions, and may allow participants to earn rewards on their holdings. Staked cryptocurrency may be secured or “locked up” (e.g., via a block on a blockchain) or a set period of time or until a certain condition occurs.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates a high-level component diagram of an illustrative blockchain system according to certain embodiments of this disclosure;

FIGS. 2A-2C illustrate example operations of methods for a crowdstaking protocol for smart projects according to certain embodiments of this disclosure;

FIGS. 3A-3B illustrate example operations of additional methods for a crowdstaking protocol for smart projects according to certain embodiments of this disclosure;

FIG. 4 illustrates an example user interface according to certain embodiments of this disclosure;

FIG. 5 illustrates an example staking pool protocol flow chart according to certain embodiments of this disclosure; and

FIG. 6 illustrates an example computer system according to certain embodiments of this disclosure.

### DETAILED DESCRIPTION

Blockchains may provide access to immutable records of information. Blockchains may be published to the public. Accordingly, since numerous computing devices (e.g. nodes) may alter the blockchain (e.g., by adding a new block), security is an important consideration when implementing a blockchain. Conventionally, to secure the blockchain, a proof of work is used that ensures reliable evidence that a significant amount of processing resources (such as time and/or processing resources) was used during the creation of a new block to be added to the blockchain. The Bitcoin implementation of blockchain requires a node to use processing resources to find a nonce value that, when hashed with the rest of a block header, results in a hash value which has a predetermined number of leading zeroes. Significant processing resources may be used to find the nonce value because the user typically has to perform numerous iterations until a suitable hash is found with the leading zeroes.

Conventional crowdfunding protocols may include paying (e.g., giving money away permanently) to receive rewards, non-profit participation, where the contribution is never returned. Further, crowdfunding protocols may include undesirable platform fees, poor transparency, security, and/or oversight, and the like. The rewards involved in crowdfunding may not include producer credit and may be very costly. A more stable, secure, and technical solution is desired to solve the issues with the conventional protocols.

In some embodiments, one or more staking pool protocols may be used to build a sustainable web3 fundraising and/or financing platform with blockchain technology that may crowdfund the development, production, and/or distribution of original studio quality films. In some embodiments, the annual percentage yield (APY) from the staking pool may fund the smart projects (e.g., films). The disclosed embodiments may provide users the opportunity to invest in smart projects (e.g., films) and receive an executive producer (EP) credit in the Internet Movie Database (IMDB), for example, all without losing their principal token (cryptocurrency) contribution.

Proof of stake (POS) may refer to miners having to pledge a “stake” of digital currency before they can validate transactions. A miner's capacity to validate blocks depends on how many coins or tokens they have put up for stake and how long they have been validating transactions. The more coins or tokens they own, the more power the miners have for mining. The miner chosen for each transaction may be chosen randomly through a weighted algorithm that takes the miners' relative power into account. A staking pool may enable multiple stakeholders to combine their computational resources as a way to increase their chances of being rewarded. Staking pools may be made up of cryptocurrency assets that multiple users combine to increase their chances of receiving rewards. In other words, stakeholders may combine their staking power in the process of verifying and validating new blocks, so the stakeholders increase their probability of earning the block rewards. A staking pool may allow cryptocurrency holders to earn passive income by contributing to a pool of funds (e.g., stored on the blockchain or in a digital wallet) that collectively earn block validation rewards (e.g., annual percentage yield, perks, digital coins, etc.) from a proof of stake blockchain. In some embodiments, by pooling their assets (e.g., cryptocurrencies) together, the participants may receive rewards together. Various rewards are discussed further herein.

In some embodiments, the staked coin may be converted back into its original cryptocurrency or into United States Dollar coin (USDC). Crowdstaking may refer to staking digital currency (e.g., cryptocurrency) to receive one or more rewards (e.g., specialized coin, perk, content, access, credit, etc.) and/or one or more actions performed as a result of a smart contract condition being met (e.g., returning your staked cryptocurrency once a certain amount of APY is met or after a certain period of time has expired). In some embodiments, crowdstaking may include profit participation in perpetuity. In some embodiments, the staked coin is returned in full, there are low transaction fees, and total transparency on all fronts since the transactions are approved and recorded in the blockchain ledger. In some embodiments, a smart contract may refer to a software program implemented in computer instructions and executed by one or more processing devices. The smart contract may be stored on the blockchain and may execute when predetermined conditions are met. The smart contract may be a self-executing program that automates the actions specified in an agreement or contract. For example, the smart contract may cause one or more digital transactions to be executed via the blockchain.

To more clearly illustrate the process used by some embodiments, the following description is provided. First, in some embodiments, a smart project (e.g., film) is launched on a crowdstaking platform in the hopes of finding delegators to back a particular smart project via the crowdstaking platform's staking pool. Upon reaching the staking goal in staked cryptocurrency, a financier or underwriter may loan a certain amount of money to produce a film. Proof of staking protocol may build value within a smart collateral wallet by acquiring APY generated based on the staked cryptocurrency. The rules that govern the staking period, the staked cryptocurrency, and the like are specified in a smart contract associated with the smart project. The staking period may be for a set period of time specified in the smart contract where the smart collateral wallet accepts APY or the staking period may close when a target value amount is collected in the smart collateral wallet. In some embodiments, once the balance in the smart collateral wallet has reached the loan value, the staking pool may end automatically based on the rules in the smart contract. However, in some embodiments, if the balance in the smart collateral wallet is not reached within the set period of time (e.g., 12 months), the staking pool may end automatically. Once the staking pool ends, the staked cryptocurrency may be converted back to its original cryptocurrency and returned to the delegators of the original cryptocurrency. For example, the original cryptocurrency may be transmitted back to digital wallets associated with the delegators.

Further, rewards and/or distributions may be made on a pro rata basis, in some embodiments, based on the delegators' contribution amounts. As described further herein, the rewards for joining a staking pool may include a specialized coin associated with the smart project, one or more perks (e.g., access to parties, events, clubs, etc.), one or more credits (e.g., executive producer), one or more contributions to a retirement plan (e.g., 401K), one or more equities (e.g., convertible note such as a share of stock), one or more content items (e.g., exclusive music and/or video), or some combination thereof. The specialized coin may refer to a digital asset that is primarily managed, stored, or exchanged on digital computer systems, especially over the internet (e.g., using a blockchain).

In some embodiments, a non-custodial staking methodology may be used where cryptocurrency holders may stake their tokens or coins with a deployed smart contract. The smart contract may control the dividends earned from the staking. The smart contract may direct at least some of the dividends and smart project revenue toward a lender as collateral (e.g., in a smart collateral wallet). In some embodiments, a lender such as film financiers, distributors, banks, and/or private lenders loan capital to produce the smart project (e.g., film). The smart project may be sold and the dividend value and the smart project sale may increase the smart contract balance, which may expedite the loan payoff. When the smart contract reaches the loan balance or a certain amount of time has passed, the smart contract expires, and the staked tokens or coins are released back to the pledgers' digital wallets and the collateral in the smart collateral wallet is deposited to the lenders' digital wallets.

In some embodiments, targeted marketing campaigns may be used to increase conversion and reach staking goals faster. For example, affiliate links may be used, influencer promotion deals may be used, video and photo targeted ads may be used, and/or brand ambassadors may be used. Further, social media networks may be used to advertise the staking pool protocol described herein.

In some embodiments, a convertible note offering may be included using the disclosed staking pool protocol. For example, an offering amount of $5,000,000 may be specified with a minimum investment of $100,000 that includes 10% interest of equity. The conversion term may be interest due at maturity, otherwise accrues and converts into equity in the qualified offering. The note term may be 2 years from closing and may convert to equity. The conversion price may be based on better of $20,000,000 valuation cap or 20% discount.

The staking pool protocol described herein may be used for any suitable smart project in any suitable industry, such as film, music publishing, real estate, non-profit/fundraising, small businesses, and the like. It should be noted that the embodiments disclosed herein may apply to any suitable industry and/or market where data security, data maintenance, data privacy, data scalability, and/or improved access for any suitable computing device is desired. For example, the disclosed techniques may provide benefits for financial transactions (e.g., money transfers, stock trading, etc.), supply chains, health industry (e.g., medical records, etc.), emergency services (e.g., police records), databases of all sorts, academic peer review scenarios, professional publication review scenarios, cyber security, and the like.

It should be noted that the disclosed embodiments may be beneficial in situations where it is desired to prevent data from being deleted. For example, storage of cryptocurrency that are used for staking pools may ensure that the cryptocurrency is returned to the original delegator/pledger when a trigger event occurs, such as the smart contract expiring, a target value amount of APY being accumulated, or the like.

As may be appreciated, the disclosed techniques provide solvency for a path forward to scale the accumulation of information using a secure blockchain that is made available to any suitable computing device.

In some embodiments, the disclosed techniques may provide one or more technical solutions to one or more technical problems. The disclosed techniques may provide a secure framework and enhanced protocol for crowdstaking cryptocurrency for smart projects using a blockchain. The disclosed techniques may lock up the staked cryptocurrency until one or more conditions are met, thereby reducing computing resources consumed by reducing the number of transmissions made over a network. That is, the staked cryptocurrency may only be released and transmitted back to a digital wallet of a participating user when the one or more conditions are met, thereby reducing the number of transmissions over the network. Further, one or more actions may be performed based on the one or more conditions being satisfied. For example, one action may include generating a specialized coin or token (e.g., digital coin or token), transmitting the specialized coin to a digital wallet of a participating user, and storing the specialized coin in a digital wallet associated with the participating user (e.g., the digital wallet is stored and maintained by a computing device of the participating user). In another example, a certain amount of annual percentage yield that is generated and stored in a smart collateral digital wallet may be transmitted to one or more other digital wallets, accounts maintained by financial institution servers (e.g., savings account, checking account, and/or retirement savings account), and the like. Further, the annual percentage yield may be transformed into a stock or convertible note that is trade via one or more exchange markets.

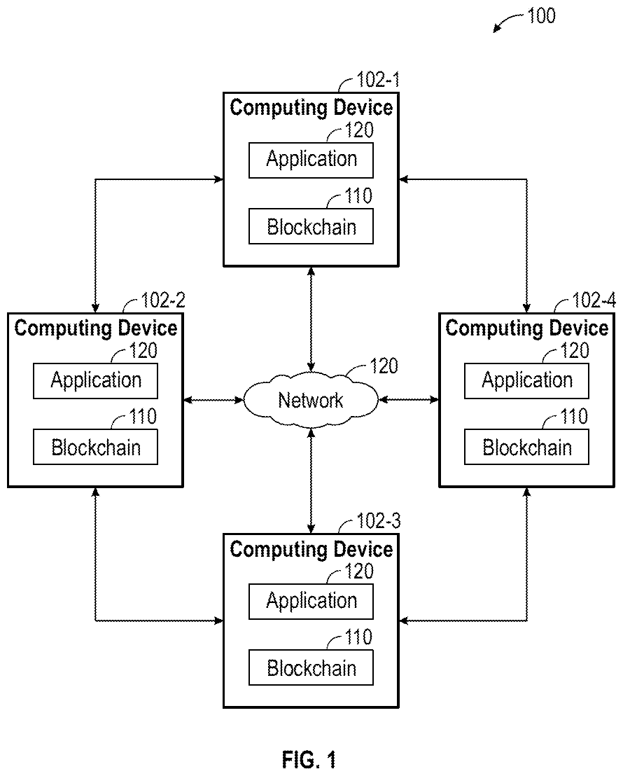

FIGS. 1 through 6, discussed below, and the various embodiments used to describe the principles of this disclosure are by way of illustration only and should not be construed in any way to limit the scope of the disclosure.

FIG. 1 illustrates a high-level component diagram of an illustrative blockchain system 100 using the crowdstaking protocol disclosed herein according to certain embodiments of this disclosure. The blockchain system 100 may include one or more computing devices 102 (e.g., 102-1, 102-2, 102-3, and 102-4), or nodes, that participate in the blockchain system 100. Any suitable number of nodes may participate in the blockchain system 100. In some embodiments, a certain minimum numbers of the nodes may be used as checks to verify the blockchain system 100 is growing as desired.

Each of the computing devices 102 may include at least one processing device, at least one memory device, and at least one network device. The computing devices 102 may be communicatively coupled to one another in a distributed fashion (e.g. a peer-to-peer network). The network devices may enable communication via a wireless protocol for transmitting data over short distances, such as Bluetooth, ZigBee, NFC, etc. Additionally, the network devices may enable communicating data over long distances, and in one example, the computing devices 102 may communicate with a network 120. Network 120 may be a public network (e.g., connected to the Internet via wired (Ethernet) or wireless (WiFi)), a private network (e.g., a local area network (LAN) or wide area network (WAN)), or a combination thereof. Network 120 may also comprise a node or nodes on the Internet of Things (IoT).

The computing devices 102 may be associated with any suitable user in any suitable industry, market, and/or ecosystem. For example, some of the users may include a film industry user, a service provider (e.g., emergency service provider (e.g., administrator, police officer, firefighter, emergency medical service user, etc.), medical personnel user, such as a physician, dentist, pharmacist, optometrist, orthodontic, nurse, etc.), a facility (e.g., medical facility user), a patient user, a victim user, a financial user, a business user, a legal user, a professional user, and/or the like.

Each computing device 102 may store the blockchain 110. The blockchain 110 may be any suitable type of blockchain. There are different kinds of blockchains, such as permission-less and permissioned. In a permission-less blockchain, any user may participate without an identity. In a permissioned blockchain, each entity that participates in the blockchain is identified and known. An example of a permissioned blockchain is a distributed ledger (e.g., a hyperledger). Permissions may cause the participating nodes to view only the appropriate transactions in the distributed ledger. Programmable logic may be implemented as rules and/or smart contracts that are executed on the blockchain 110. Some or all of the operations of any method described herein may be implemented in programmable logic executed on the blockchain 110.

Each user may be associated with a respective computing device that they use to register as a node on the blockchain system 100 and request transactions to be performed using a blockchain 110. During registration, each user may provide certain information pertaining to the user to be maintained by the blockchain 110 at the nodes. Each node (e.g., computing device 102) may maintain a respective copy of the blockchain 110 as a shared single source of truth.

To elaborate, a request may be received from a computing device to join the blockchain system 100. The computing device may be a node that identifies itself upon joining the blockchain system 100 in the request. Upon joining the blockchain system based on the information in the request, the node requests to download the blockchain 110 up to its current state.

Computer instructions may be implemented that perform one or more of the operations of one or more of the methods described herein and may reside on and be executed by one or more of the computing devices 102. Each of the computing devices 102 may be any suitable computing device, such as a server, laptop, tablet, smartphone, mobile computing device, or computer. Each of the computing devices 102 may include a display that is capable of presenting a user interface of an application 120. The application 120 may be implemented in computer instructions stored on the one or more memory devices of each of the computing devices 102 and executable by the one or more processing devices of each of the computing devices 102. The application 120 may enable a user to make transaction requests to use the blockchain 110 and/or interact with the blockchain 110.

For example, in some embodiments, the user may make requests to fund certain smart projects by pledging their cryptocurrency to be locked up for a certain period of time to enable the annual percentage yield accumulated to be apportioned to the smart project in return for the recoupment of the cryptocurrency and/or one or more perks, rewards, or the like. The blockchain 110 may be used to securely store the transactions related to cryptocurrency that are staked in a staking pool from being deleted and thereby providing full transparency to a smart project. In some embodiments, the disclosed crowdstaking protocol may enable profit sharing among participating users when profits of annual percentage yield exceed a loan amount plus a percentage specified by the lender. The profits may be distributed in a pro rata manner based on initial contribution.

After computing devices 102 are participating in the blockchain system 100, an initial genesis node may be generated by a node 102 and/or 104 in the blockchain system 100. The node may execute computer instructions that specify how to generate the initial genesis node. For example, the computer instructions may specify the variables to use to generate the initial genesis block, a hash function to execute to obtain a hash of the initial genesis block, a nonce value, and the like. A genesis block may not refer to any previous blocks, since the genesis block is the first block in the blockchain 110.

After the initial genesis block is created and added to the blockchain 110, in some embodiments, the nodes 102 may use a proof of work technique to add additional blocks to the blockchain 110. The proof of work technique may hash together sender information, receiver information, previous block header, information, accompanying transaction information for all transactions in the blocks of the blockchain 110, a nonce variable, and the like.

The hash that is output may include an assortment of leading 0's prior to the block being added to the blockchain 110. As such, several iterations of the proof of work concept may be performed until a nonce variable is identified that provides the appropriate leading 0's in the hash. The first node 102 to achieve a correct hash for a given set of data may be provided a first reward (e.g., digital token) for successfully performing the proof of work technique. The value of the first reward may be commensurate with the function performed (e.g., since the proof of work technique was performed for one block, the value of the reward may be one). After the block is added to the blockchain 110, the node that calculates the correct hash broadcasts the corresponding block to the other nodes to update their respective blockchains 110.

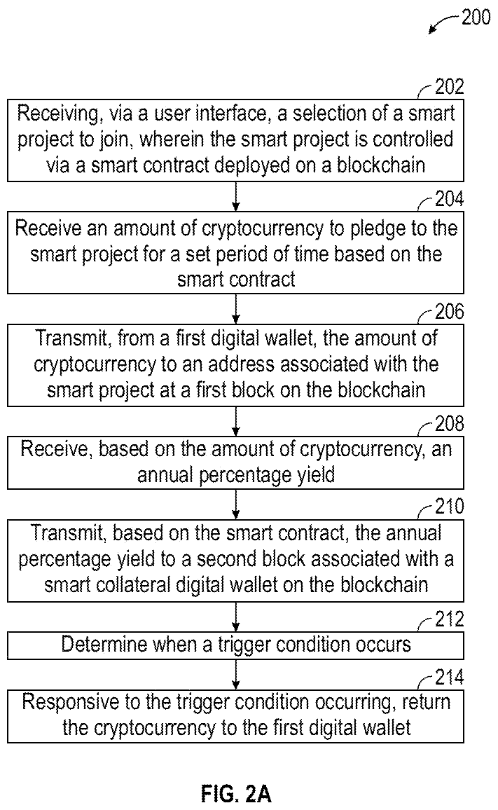

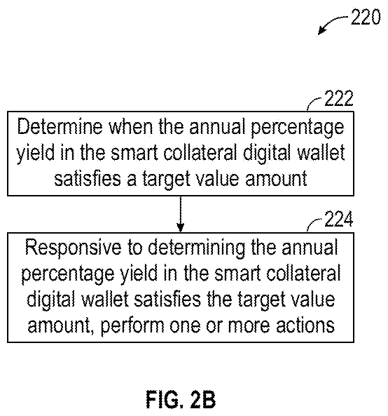

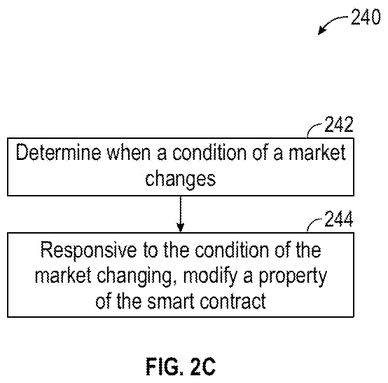

FIGS. 2A-2C illustrate example operations of methods 200, 220, and 240 for a crowdstaking protocol for smart projects according to certain embodiments of this disclosure;

Regarding FIG. 2A, the method 200 may include operations for crowdstaking protocol for smart projects, where the operations may by processing logic that may include hardware (circuitry, dedicated logic, etc.), software (such as is run on a general purpose computer system or a dedicated machine), or a combination of both. The method 200 and/or each of their individual functions, routines, subroutines, or operations may be performed by one or more processors of a computing device (e.g., any component or combination of components of the blockchain system 100 of FIG. 1, such as node 102 etc.). In certain implementations, the method 200 may be performed by a single processing thread. Alternatively, the method 200 may be performed by two or more processing threads, each thread implementing one or more individual functions, routines, subroutines, or operations of the methods.

For simplicity of explanation, the method 200 is depicted and described as a series of operations. However, operations in accordance with this disclosure can occur in various orders and/or concurrently, and with other operations not presented and described herein. For example, the operations depicted in the method 200 may occur in combination with any other operation of any other method disclosed herein. Furthermore, not all illustrated operations may be required to implement the method 200 in accordance with the disclosed subject matter. In addition, those skilled in the art will understand and appreciate that the method 200 could alternatively be represented as a series of interrelated states via a state diagram or events.

At 202, the processing device may receive, via a user interface of an application 120, a selection of a smart project to join. The smart project may be related to any suitable industry, such as film, business, non-profit, philanthropic, etc. The smart project may be controlled via a smart contract deployed on a blockchain 110. In some embodiments, the smart project may be associated with various properties and/or attributes, such as a name, title, description, target pledge amount (e.g., cryptocurrency or other digital currency), rewards, etc. In some embodiments, the smart project may be a film that is being produced, a video game, a television show, any suitable content, a festival, any suitable social event, or the like.

At 204, the processing device may receive an amount of cryptocurrency to pledge to the smart project for a set period of time based on the smart contract. The set period of time may be specified as a rule by the smart contract. The set period of time may be any configurable amount and may be dynamically changed. For example, based on one or more conditions of a market (e.g., stock, cryptocurrency), the set period of time may be modified (e.g., extended or reduced).

At 206, the processing device may transmit, from a first digital wallet, the amount of cryptocurrency to an address associated with the smart project at a first block on the blockchain 110. The cryptocurrency may be stored and secured via the first block on the blockchain once received.

At 208, the processing device may receive, based on the amount of cryptocurrency, an annual percentage yield. The cryptocurrency may be converted to staked cryptocurrency when a target value amount of the cryptocurrency is reached. The staked cryptocurrency may lock the staked cryptocurrency at a block or digital wallet associated with the smart contract and/or smart project. Receipt coins or tokens (e.g., digital coins or digital tokens) may be generated for the staked cryptocurrency and transmitted to digital wallets of users that pledged the cryptocurrency to fund the smart project.

At 210, the processing device may transmit, based on the smart contract, the annual percentage yield to a second block associated with a smart collateral digital wallet on the blockchain 110.

At 212, the processing device may determine when a trigger condition occurs.

At 214, responsive to the trigger condition occurring, the processing device may return the cryptocurrency to the first digital wallet.

In some embodiments, the processing device may receive and/or transmit a reward after the trigger condition occurs. The reward may include a certain specialized coin associated with the smart project, a perk associated with the smart project, a convertible note, an executive producer credit associated with the smart project, or some combination thereof.

In some embodiments, the processing device may convert the cryptocurrency from a first type of coin (e.g., Ethereum) to a staked type of coin (e.g., staked Ethereum). In some embodiments, the processing device may execute an oracle (e.g., software application) to check for one or more trigger conditions occurring. The one or more trigger conditions may include the set amount of time specified in the smart contract expiring, a condition associated with a market occurring, a certain amount of value accumulating in the smart collateral digital wallet (where the value is associated with the cryptocurrency, the annual percentage yield, or some combination thereof), or some combination thereof.

Regarding FIG. 2B, the method 220 may include operations for crowdstaking protocol for smart projects, where the operations may by processing logic that may include hardware (circuitry, dedicated logic, etc.), software (such as is run on a general purpose computer system or a dedicated machine), or a combination of both. The method 220 and/or each of their individual functions, routines, subroutines, or operations may be performed by one or more processors of a computing device (e.g., any component or combination of components of the blockchain system 100 of FIG. 1, such as node 102 etc.). In certain implementations, the method 220 may be performed by a single processing thread. Alternatively, the method 220 may be performed by two or more processing threads, each thread implementing one or more individual functions, routines, subroutines, or operations of the methods.

For simplicity of explanation, the method 220 is depicted and described as a series of operations. However, operations in accordance with this disclosure can occur in various orders and/or concurrently, and with other operations not presented and described herein. For example, the operations depicted in the method 220 may occur in combination with any other operation of any other method disclosed herein. Furthermore, not all illustrated operations may be required to implement the method 220 in accordance with the disclosed subject matter. In addition, those skilled in the art will understand and appreciate that the method 220 could alternatively be represented as a series of interrelated states via a state diagram or events.

At 222, the processing device may determine when the annual percentage yield in the smart collateral digital wallet satisfies a target value amount. The annual percentage yield may refer to a real rate of return earned on an investment, taking into account the effect of compounding interest over a year. A smart collateral wallet may refer to software, an electronic device, or an online service that enables making transactions and/or storing monetary values (e.g., annual percentage yields) and/or cryptocurrency.

At 224, responsive to determining the annual percentage yield in the smart collateral digital wallet satisfies the target value amount, the processing device may perform one or more actions. In some embodiments, the one or more actions may include releasing the cryptocurrency by transmitting at least some of the cryptocurrency to the digital wallet, transmitting, to a third digital wallet or a bank account, at least some of the annual percentage yield, transmitting, to the digital wallet, a specialized coin associated with the smart project, transmitting, to a retirement savings account, at least some of the annual percentage yield, or some combination thereof. In some embodiments, the smart collateral digital wallet and/or the digital wallet may be a cryptocurrency wallet. The transmitting may transfer at least some of the cryptocurrency, annual percentage yield, and/or specialized coin from one storage medium (e.g., a block on a blockchain, a smart collateral digital wallet, etc.) to a separate storage medium (e.g., the digital wallet, a server hosting an account (e.g., retirement savings account)) via a network. In some embodiments, the processing device may generate the specialized coin based on the smart project that was selected.

Regarding FIG. 2C, the method 240 may include operations for crowdstaking protocol for smart projects, where the operations may by processing logic that may include hardware (circuitry, dedicated logic, etc.), software (such as is run on a general purpose computer system or a dedicated machine), or a combination of both. The method 240 and/or each of their individual functions, routines, subroutines, or operations may be performed by one or more processors of a computing device (e.g., any component or combination of components of the blockchain system 100 of FIG. 1, such as node 102 etc.). In certain implementations, the method 240 may be performed by a single processing thread. Alternatively, the method 240 may be performed by two or more processing threads, each thread implementing one or more individual functions, routines, subroutines, or operations of the methods.

For simplicity of explanation, the method 240 is depicted and described as a series of operations. However, operations in accordance with this disclosure can occur in various orders and/or concurrently, and with other operations not presented and described herein. For example, the operations depicted in the method 240 may occur in combination with any other operation of any other method disclosed herein. Furthermore, not all illustrated operations may be required to implement the method 240 in accordance with the disclosed subject matter. In addition, those skilled in the art will understand and appreciate that the method 240 could alternatively be represented as a series of interrelated states via a state diagram or events.

At 242, the processing device may determine when a condition of a market changes (e.g., cryptocurrency market, global electronic marketplace for buying and trading securities, etc.). In one example, a condition of a market may change when the price of a stock changes (e.g., increases or decreases), the price of cryptocurrency changes (e.g., increases or decreases), etc. Cryptocurrency may refer to a digital currency, which may be an alternative form of payment created using encryption algorithms. The condition of the market may change when prices and/or rates change as supply or demand changes. Further, conditions of markets may change when sales increase or decrease, profitability increases or decreases, new competitors emerging, changing buyer titles, and the like.

At 244, responsive to the condition of the market changing, the processing device may modify a property of the smart contract. The condition may include an increase or decrease in value, and the property may include modifying a property of the smart contract (e.g., extending a period of time specified in the smart contract to keep a staking pool open and cryptocurrency locked up). Keeping cryptocurrency locked up may refer to securing the cryptocurrency at a storage medium (e.g., block on a blockchain), such that the cryptocurrency is prevented from being released or transmitted or altered.

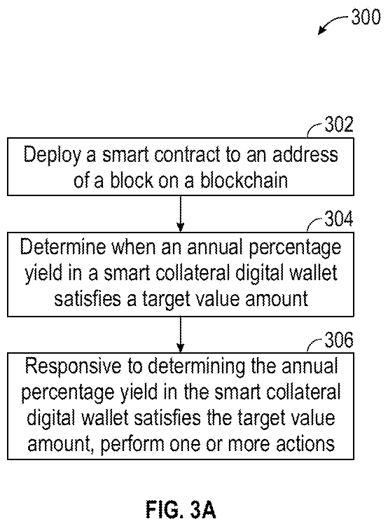

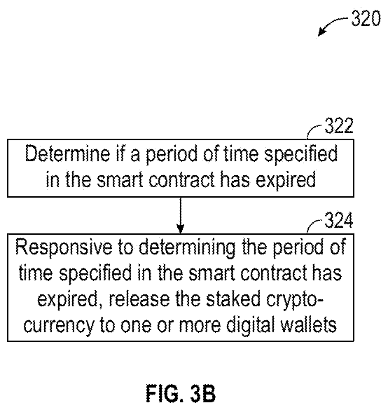

FIGS. 3A-3B illustrate example operations of additional methods 300 and 320 for a crowdstaking protocol for smart projects according to certain embodiments of this disclosure;

Regarding FIG. 3A, the method 300 may include operations for crowdstaking protocol for smart projects, where the operations may by processing logic that may include hardware (circuitry, dedicated logic, etc.), software (such as is run on a general purpose computer system or a dedicated machine), or a combination of both. The method 300 and/or each of their individual functions, routines, subroutines, or operations may be performed by one or more processors of a computing device (e.g., any component or combination of components of the blockchain system 100 of FIG. 1, such as node 102 etc.). In certain implementations, the method 300 may be performed by a single processing thread. Alternatively, the method 300 may be performed by two or more processing threads, each thread implementing one or more individual functions, routines, subroutines, or operations of the methods.

For simplicity of explanation, the method 300 is depicted and described as a series of operations. However, operations in accordance with this disclosure can occur in various orders and/or concurrently, and with other operations not presented and described herein. For example, the operations depicted in the method 300 may occur in combination with any other operation of any other method disclosed herein. Furthermore, not all illustrated operations may be required to implement the method 300 in accordance with the disclosed subject matter. In addition, those skilled in the art will understand and appreciate that the method 300 could alternatively be represented as a series of interrelated states via a state diagram or events.

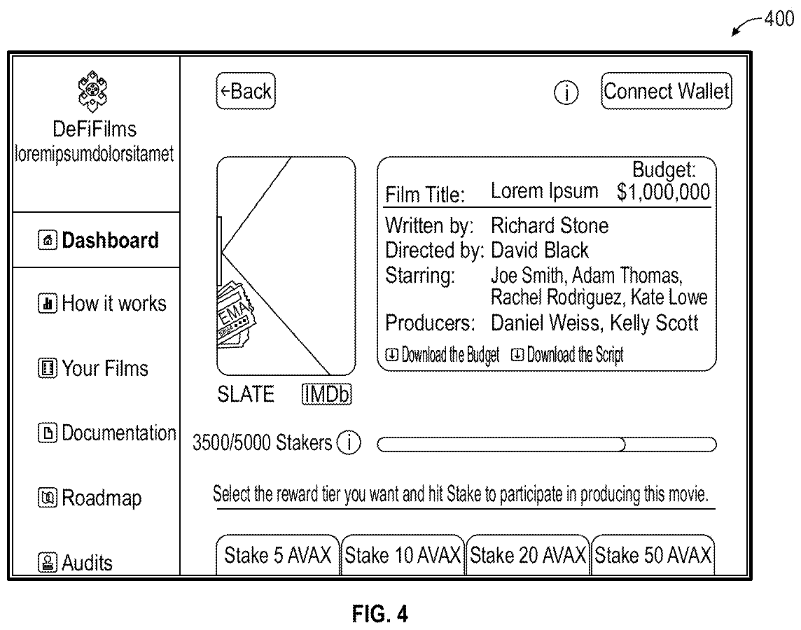

At 302, the processing device may deploy a smart contract to an address of a block on a blockchain. The smart contract may specify one or more rules associated with a smart project. The smart project may have been selected from a user interface (e.g., the UI 400 shown in FIG. 4). In some embodiments, the one or more rules specify when to start accepting the staked cryptocurrency in a staking pool, how long to keep the staking pool open, how much of the annual percentage yield is required to satisfy a target value amount, or some combination thereof.

At 304, the processing device may determine when an annual percentage yield in a smart collateral digital wallet satisfies a target value amount. The annual percentage yield may be generated based on staked cryptocurrency in a second digital wallet separate from the smart collateral digital wallet. The staked cryptocurrency may be associated with the smart project.

At 306, responsive to determining the annual percentage yield in the smart collateral digital wallet satisfies the target value amount, the processing device may perform one or more actions. The one or more actions may include transmitting, to a third digital wallet associated with a user, at least some of the cryptocurrency, transmitting, to the third digital wallet, a specialized coin associated with the smart project, creating an executive producer credit associated with the smart project, transmitting, to an account (e.g., an account of a lender), at least some of the annual percentage yield, or some combination thereof. In some embodiments, the one or more actions may include providing a convertible note associated with the smart contract to a digital wallet and/or account associated with a user who pledged cryptocurrency to fund the smart project. In some embodiments, the one or more actions may include distributing pro rata to one or more digital wallets associated with users that pledged cryptocurrency to fund the smart project. In some embodiments, the one or more actions may include providing equity to an account associated with a user who pledged cryptocurrency to fund the smart project. In some embodiments, the one or more actions may include converting the staked cryptocurrency into at least one of cryptocurrency and United States dollar coin (USDC). In some embodiments, the one or more actions may include providing content to a computing device associated with a user who pledged cryptocurrency to fund the smart project. In some embodiments, to comply with one or more federal regulations, the one or more actions may include declining additional annual percentage yield amounts from being added to the smart collateral wallet.

In some embodiments, the processing device may determine when a value of cryptocurrency reaches a target value amount. In some embodiments, the target value amount may include a loan value amount plus an additional percentage value amount, and the one or more actions may include transmitting the annual percentage yield to an account associated with an underwriter of a loan. In some embodiments, responsive to determining the value of the cryptocurrency reaches the target value amount, the processing device may convert the cryptocurrency to the staked cryptocurrency, and transmit one or more receipt coins or tokens to a third digital wallet associated with a user who pledged the cryptocurrency to fund the smart project.

In some embodiments, the processing device may determine when a trigger condition occurs. Responsive to the trigger condition occurring, the processing device may modify a property of the smart contract. In some embodiments, the trigger condition may include a change to a value in a market, and the property may include modifying a period of time associated with the smart contract.

Regarding FIG. 3B, the method 320 may include operations for crowdstaking protocol for smart projects, where the operations may by processing logic that may include hardware (circuitry, dedicated logic, etc.), software (such as is run on a general purpose computer system or a dedicated machine), or a combination of both. The method 320 and/or each of their individual functions, routines, subroutines, or operations may be performed by one or more processors of a computing device (e.g., any component or combination of components of the blockchain system 100 of FIG. 1, such as node 102 etc.). In certain implementations, the method 320 may be performed by a single processing thread. Alternatively, the method 320 may be performed by two or more processing threads, each thread implementing one or more individual functions, routines, subroutines, or operations of the methods.

For simplicity of explanation, the method 320 is depicted and described as a series of operations. However, operations in accordance with this disclosure can occur in various orders and/or concurrently, and with other operations not presented and described herein. For example, the operations depicted in the method 320 may occur in combination with any other operation of any other method disclosed herein. Furthermore, not all illustrated operations may be required to implement the method 320 in accordance with the disclosed subject matter. In addition, those skilled in the art will understand and appreciate that the method 320 could alternatively be represented as a series of interrelated states via a state diagram or events.

At 322, the processing device may determine if a period of time specified in the smart contract has expired.

At 324, responsive to determining the period of time specified in the smart contract has expired, the processing device may release the staked cryptocurrency to one or more digital wallets.

FIG. 4 illustrates an example user interface 400 of the application 120 executing on a computing device 102-1 according to certain embodiments of this disclosure. The user interface 400 includes a dashboard screen where a user can select to join a staking pool by connecting their digital wallet to a smart contract associated with a smart project. The user may select to stake any suitable cryptocurrency that is accepted by the staking pool and/or the smart contract. As depicted, the dashboard user interface includes options to stake 5 AVAX, 10 AVAX, 20 AVAX, or 50 AVAX. Once the cryptocurrency is chosen to be pledged to a certain smart project, the cryptocurrency may be converted to a staked type of cryptocurrency and receipt tokens or coins may be transmitted from the blockchain 110 to the digital wallet associated with the user operating the user interface of the application 120. The smart project in the depicted example is a film titled “Lorem Ipsum” with a budget of $1,000,000 and a goal of 5,000 stakers. Currently there are 3,500 stakers. The user may also select a reward tier associated with the cryptocurrency they want to stake and participate in producing the film. Certain rewards include receiving a specialized coin or token associated with the smart project, certain executive producer credit, certain content, certain perks, certain access, certain permissions, and the like.

Each computing device 102 may present the user interface 400 of the application 120, and may enable each user to select a smart project to join and stake their cryptocurrency. In some embodiments, the cryptocurrency that is staked may be returned in full to the digital wallet associated with the user when a trigger condition occurs, such as the budget (target value amount set in the smart contract) being satisfied or a certain period of time expiring (set in the smart contract).

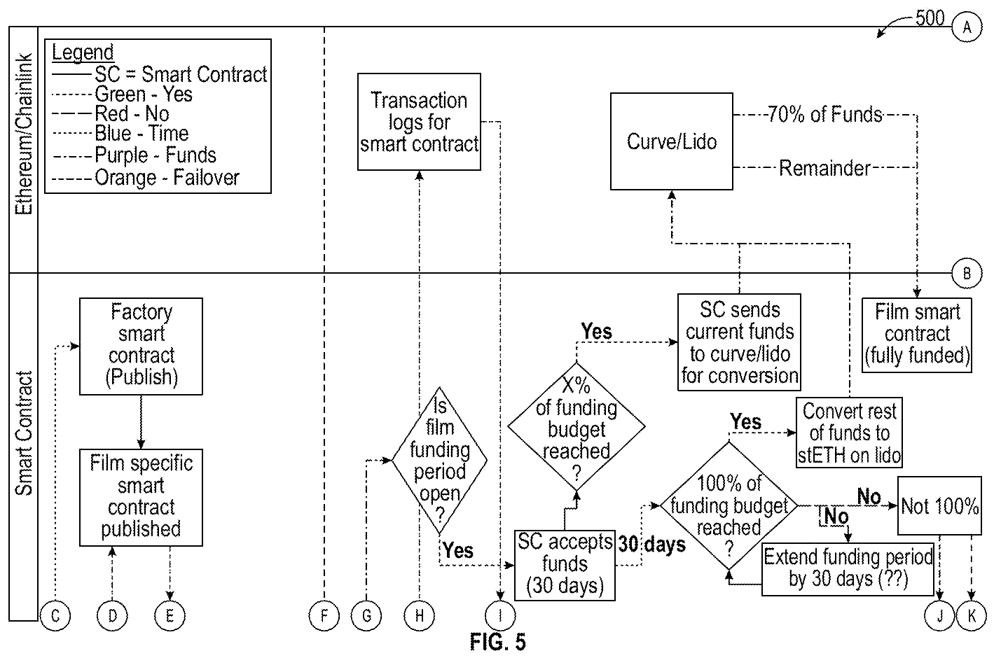

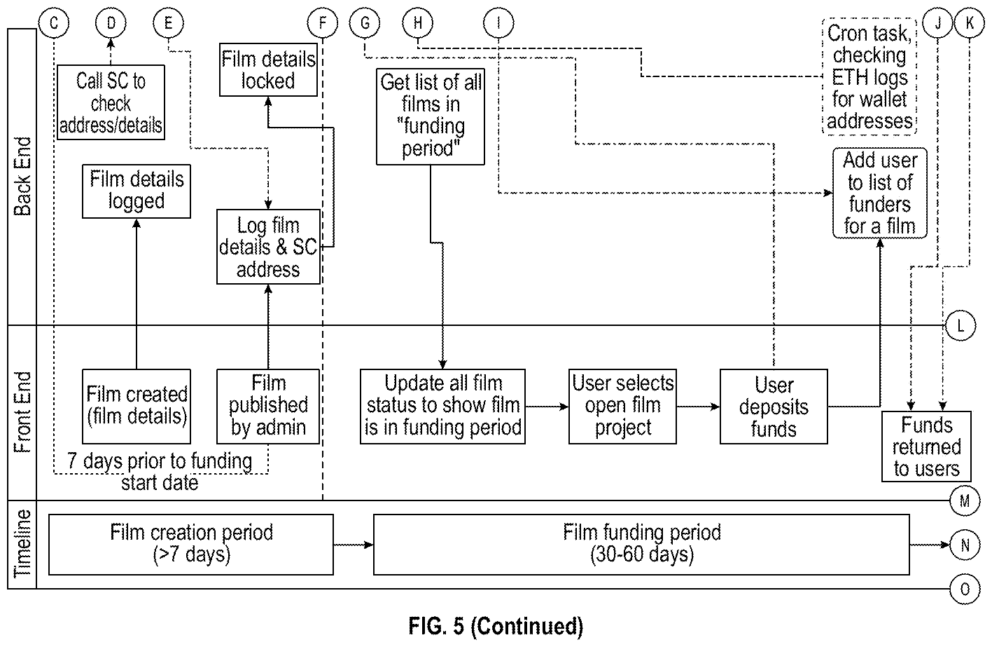

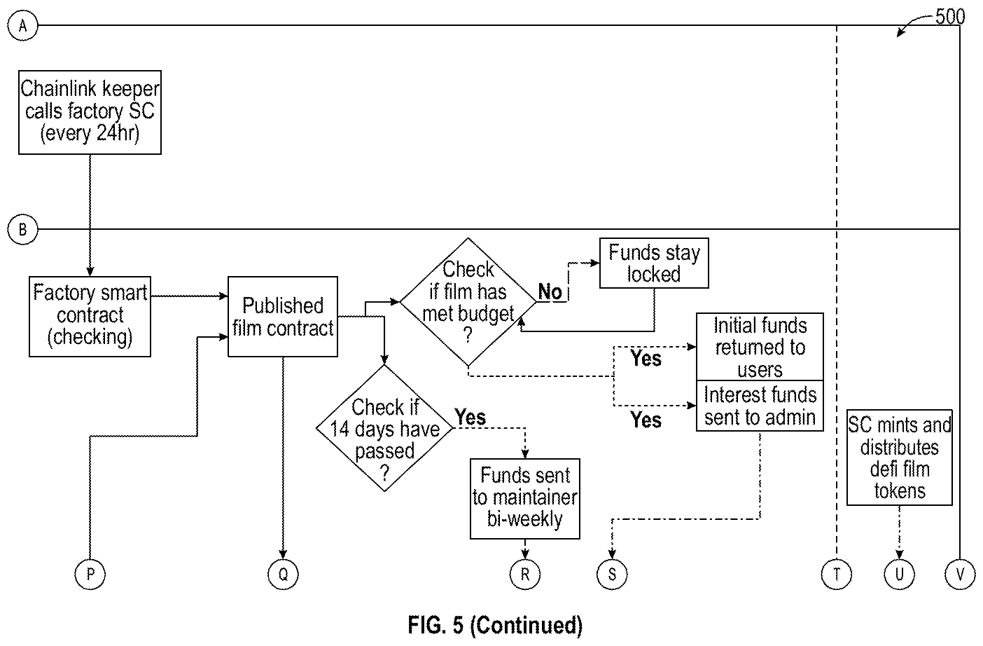

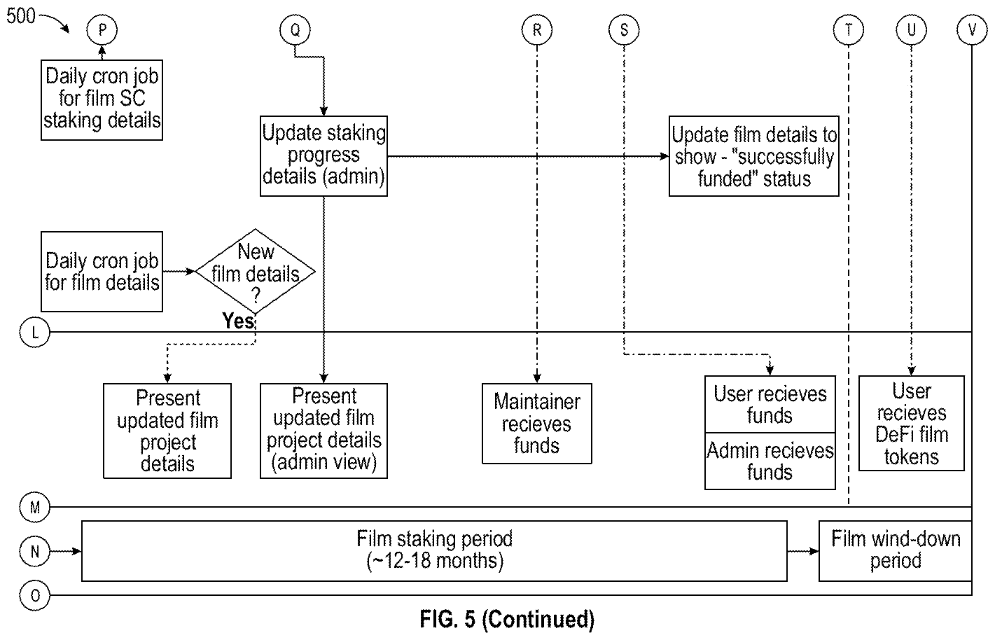

FIG. 5 illustrates an example staking pool protocol (also referred to as crowdstaking protocol) flow chart 500 according to certain embodiments of this disclosure. The depicted staking pool protocol flow chart 500 is associated with the film industry but any suitable industry may be applicable. There is a horizontal row titled “Timeline” that includes 4 different periods depicted in the flow chart 500, and they are associated with 4 vertical sections. A first period includes a film creation period, a second period includes a film funding period, a third period includes a film staking period, and a fourth period includes a film wind-down period.

Further, a legend includes different keys and their associated values. For example, the legend indicates that “SC” key is associated with a “Smart Contract” value, a “Green” key is associated with a “Yes” value, and so forth.

In addition, there are 3 horizontal rows that are depicted that are associated with “Front End” actions, “Back End” actions, “Smart Contract” actions, and Ethereum/Chainlink actions. In the first vertical section associated with the “Film Creation Period”, the film is created with film details in the “Front End” and the film details are logged in the “Back End”. Further, the film published by administration in the “Front End”, which causes the film to be created and a smart contract (SC) address to be logged. Then, the film details are locked in the blockchain at the smart contract address at the “Back End”. Also, the “Back End” calls the smart contract (SC) to check address and details. The film specific smart contract is published to the blockchain 110 at the address specified. In some embodiments, a factory model may be used where a factory smart contract is used to publish the film specific smart contract. The properties of the smart contract may include a set period of time to keep the staking pool open, a set period of time for a budget to be reached by the pledged cryptocurrency before terminating the smart contract, a target value amount to be raised by the cryptocurrency that is pledged prior to opening the staking pool, a target value amount to be accumulated by the smart collateral digital wallet, and the like.

In the “Film Funding Period” vertical section of the “Timeline” horizontal row, the “Back End” may retrieve a list of all films in “Funding Period”. The “Front End” may update all film status to show the films that are in the “Funding Period”. Then, the user may select an open film project (e.g., smart project) to fund and the user may deposit funds. The “Back End” may add the user to a list of funders for a smart project. Further, the “Back End” check various logs for wallet addresses (e.g., user digital wallet, smart collateral digital wallet, lender digital wallet, other digital wallets, etc.).

In the “Smart Contract” horizontal row of the “Film Funding Period”, a processing device may execute a smart contract to determine whether a film funding period is open. If yes, then the smart contract may accept funds for a set period of time set by the smart contract (e.g., 30 days). The smart contract may determine whether X % of the funding budget is reached. If yes, the smart contract may send the current funds to Curve®/Lido® for conversion to staked cryptocurrency.

Further, after the set period of time expires for the smart contract, the processing device may determine whether 100% of the funding budget is reached. If yes, the processing device may convert the rest of the funds to staked cryptocurrency for. In some embodiments, if not 100% of the budget is reached at the end of the set period of time, then the funds may be returned to the users per the smart contract. In some embodiments, if not 100% of the budget is reached at the end of the set period of time, then the funding period may be extended for another set period of time and the check of whether 100% of funding budget is reached may be repeated.

The staked cryptocurrency may be used to indicate the film is fully funded per the smart contract. Accordingly, the “Film Staking Period” vertical section of the flow chart 500 may be initiated. In the depicted section, the processing device may determine whether the film has met budget by checking a smart collateral digital wallet that includes annual percentage yield accumulated based on the staked cryptocurrency that is locked up in the blockchain 110. If the film budget is met, then the initial funds (cryptocurrency) are returned to the appropriate users, and the interest funds (annual percentage yield) funds are sent to the administrator at the “Smart Contract” horizontal row. At the “Front End” horizontal row, the user may receive their initial funds in their user digital wallet, and the administrator (e.g., lender) may receive the annual percentage yield funds to recoup their loan. Further, if the film budget is not met, then the cryptocurrency remains locked until the film budget is met.

Also, during the “Smart Contract” horizontal row, the processing device may check if a certain period of time has passed, and if so, the funds that are accumulated are sent to a maintainer digital wallet. On the “Front End”, the maintainer digital wallet receives the funds and stores them in the blockchain.

When the smart project is fully funded based on the annual percentage yield, the staking progress details may be updated at the “Back End”, and the updated film project details may be presented in the user interface of an application 120 on the “Front End”.

In the “Film Wind-Down Period”, the processing device mints a specialized coin or token associated with the smart project to transmit to the user's digital wallet when the film budget has been met or when the user chooses to participate in the staking pool. At the “Front End”, the user's digital wallet receives the specialized coin or token, which may be presented in a user interface.

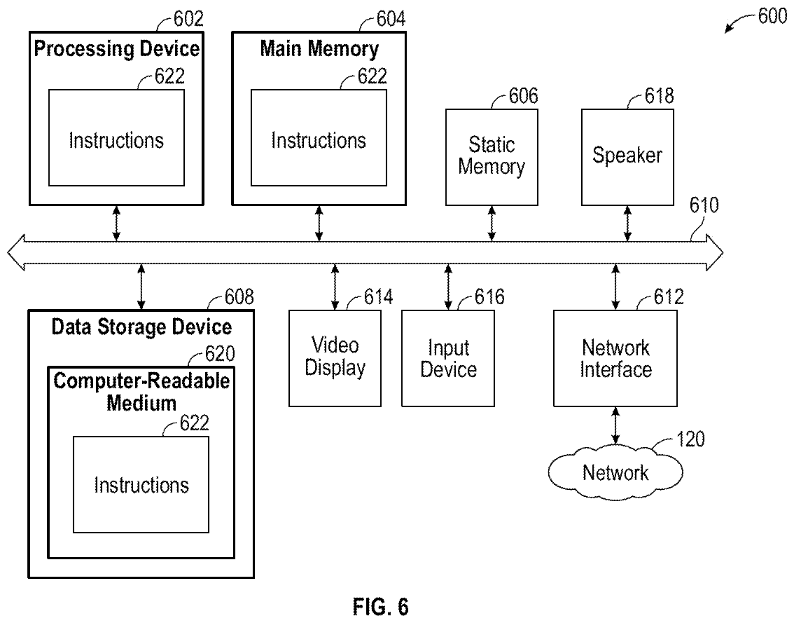

FIG. 6 illustrates example computer system 600 which can perform any one or more of the methods described herein, in accordance with one or more aspects of the present disclosure. In one example, computer system 600 may correspond to the computing devices 102, or any suitable component of FIG. 1. The computer system 600 may be capable of executing application 120 and connecting to and interacting with the blockchain 110 via the application 120 of FIG. 1. The computer system 600 may be connected (e.g., networked) to other computer systems (e.g., other node) in the blockchain system 100 via a LAN, an intranet, an extranet, or the Internet. The computer system 600 may participate in the blockchain system 100. The computer system may operate in the capacity of a server in a client-server network environment. The computer system may be a personal computer (PC), a tablet computer, a wearable (e.g., wristband), a set-top box (STB), a personal Digital Assistant (PDA), a mobile phone, a camera, a video camera, a sensor, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 600 includes a processing device 602, a main memory 604 (e.g., read-only memory (ROM), flash memory, solid state drives (SSDs), dynamic random access memory (DRAM) such as synchronous DRAM (SDRAM)), a static memory 606 (e.g., flash memory, solid state drives (SSDs), static random access memory (SRAM)), and a data storage device 608, which communicate with each other via a bus 610.

Processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a system on a chip, a field programmable gate array (FPGA), a digital signal processor (DSP), network processor, or the like. The processing device 602 is configured to execute instructions for performing any of the operations and steps of any method discussed herein.

The computer system 600 may further include a network interface device 612. The computer system 600 also may include a video display 614 (e.g., a liquid crystal display (LCD), a light-emitting diode (LED), an organic light-emitting diode (OLED), a quantum LED, a cathode ray tube (CRT), a shadow mask CRT, an aperture grille CRT, a monochrome CRT), one or more input devices 616 (e.g., a keyboard and/or a mouse), and one or more speakers 618 (e.g., a speaker). In one illustrative example, the video display 614 and the input device(s) 616 may be combined into a single component or device (e.g., an LCD touch screen).

The data storage device 616 may include a computer-readable medium 620 on which the instructions 622 embodying any one or more of the methods, operations, or functions described herein is stored. The instructions 622 may also reside, completely or at least partially, within the main memory 604 and/or within the processing device 602 during execution thereof by the computer system 600. As such, the main memory 604 and the processing device 602 also constitute computer-readable media. The instructions 622 may further be transmitted or received over a network via the network interface device 612.

While the computer-readable storage medium 620 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

Consistent with the above disclosure, the examples of systems and method enumerated in the following clauses are specifically contemplated and are intended as a non-limiting set of examples.

Clause 1. A computer-implemented method comprising:
receiving, via a user interface, a selection of a smart project to join, wherein the smart project is controlled via a smart contract deployed on a blockchain;
receiving an amount of cryptocurrency to pledge to the smart project for a set period of time based on the smart contract;
transmitting, from a first digital wallet, the amount of cryptocurrency to an address associated with the smart project at a first block on the blockchain;
receiving, based on the amount of cryptocurrency, an annual percentage yield;
transmitting, based on the smart contract, the annual percentage yield to a second block associated with a smart collateral digital wallet on the blockchain;
determining when a trigger condition occurs;
responsive to the trigger condition occurring, returning the cryptocurrency to the first digital wallet.

Clause 2. The computer-implemented method of any clause herein, further comprising receiving a reward after the trigger condition occurs, wherein the reward comprises a certain coin associated with the smart project, a perk associated with the smart project, a convertible note, an executive producer credit associated with the smart project, or some combination thereof.

Clause 3. The computer-implemented method of any clause herein, further comprising:

determining when the annual percentage yield in the smart collateral digital wallet satisfies a target value amount; and

responsive to determining the annual percentage yield in the smart collateral digital wallet satisfies the target value amount, performing one or more actions.

Clause 4. The computer-implemented method of any clause herein, wherein the one or more actions comprise:
releasing the cryptocurrency by transmitting at least some of the cryptocurrency to the digital wallet,
transmitting, to a third digital wallet or a bank account, at least some of the annual percentage yield,
transmitting, to the digital wallet, a specialized coin associated with the smart project,

transmitting, to a retirement savings account, at least some of the annual percentage yield, or some combination thereof.

Clause 5. The computer-implemented method of any clause herein, further comprising:

determining when a condition of a market changes; and

responsive to the condition of the market changing, modifying a property of the smart contract.

Clause 6. The computer-implemented method of any clause herein, wherein the condition comprises an increase or a decrease in value, and wherein the property comprises modifying a period of time associated with the smart contract.

Clause 7. The computer-implemented method of any clause herein, further comprising converting the cryptocurrency from a first type of coin to a staked type of coin.

Clause 8. The computer-implemented method of any clause herein, further comprising using an oracle to check for one or more trigger conditions, wherein:

the trigger condition comprises the set amount of time expiring,
the trigger condition comprises a condition associated with a market occurring,
the trigger condition comprises a certain amount of value accumulating, wherein the value is associated with the cryptocurrency, the annual percentage yield, or some combination thereof, or
some combination thereof.

Clause 9. A system comprising:

a memory device storing instructions; and

a processing device communicatively coupled to the memory device, wherein the processing device executes the instructions to:

receive, via a user interface, a selection of a smart project to join, wherein the smart project is controlled via a smart contract deployed on a blockchain;

receive an amount of cryptocurrency to pledge to the smart project for a set period of time based on the smart contract;

transmit, from a first digital wallet, the amount of cryptocurrency to an address associated with the smart project at a first block on the blockchain;

receive, based on the amount of cryptocurrency, an annual percentage yield;

transmit, based on the smart contract, the annual percentage yield to a second block associated with a smart collateral digital wallet on the blockchain;

determine when a trigger condition occurs; and

responsive to the trigger condition occurring, return the cryptocurrency to the first digital wallet.

Clause 10. The system of any clause herein, wherein the processing device is further configured to receive a reward after the trigger condition occurs, wherein the reward comprises a certain coin associated with the smart project, a perk associated with the smart project, a convertible note, an executive producer credit associated with the smart project, or some combination thereof.

Clause 11. The system of any clause herein, wherein the processing device is further configured to:

determine when the annual percentage yield in the smart collateral digital wallet satisfies a target value amount; and

responsive to determining the annual percentage yield in the smart collateral digital wallet satisfies the target value amount, perform one or more actions.

Clause 12. The system of any clause herein, wherein the one or more actions comprise:

releasing the cryptocurrency by transmitting at least some of the cryptocurrency to the digital wallet,

transmitting, to a third digital wallet or a bank account, at least some of the annual percentage yield,

transmitting, to the digital wallet, a specialized coin associated with the smart project,

transmitting, to a retirement savings account, at least some of the annual percentage yield, or

some combination thereof.

Clause 13. The system of any clause herein, wherein the processing device is further configured to:

determine when a condition of a market changes; and

responsive to the condition of the market changing, modify a property of the smart contract.

Clause 14. The system of any clause herein, wherein the condition comprises an increase or a decrease in value, and wherein the property comprises modifying a period of time associated with the smart contract.

Clause 15. The system of any clause herein, wherein the processing device is further configured to convert the cryptocurrency from a first type of coin to a staked type of coin.

Clause 16. The system of any clause herein, wherein the processing device is further configured to use an oracle to check for one or more trigger conditions, wherein:

the trigger condition comprises the set amount of time expiring,

the trigger condition comprises a condition associated with a market occurring,

the trigger condition comprises a certain amount of value accumulating, wherein the value is associated with the cryptocurrency, the annual percentage yield, or some combination thereof, or

some combination thereof.

Clause 17. A tangible, non-transitory computer-readable medium storing instructions that, when executed, cause a processing device to:

receive, via a user interface, a selection of a smart project to join, wherein the smart project is controlled via a smart contract deployed on a blockchain;

receive an amount of cryptocurrency to pledge to the smart project for a set period of time based on the smart contract;

transmit, from a first digital wallet, the amount of cryptocurrency to an address associated with the smart project at a first block on the blockchain;

receive, based on the amount of cryptocurrency, an annual percentage yield;

transmit, based on the smart contract, the annual percentage yield to a second block associated with a smart collateral digital wallet on the blockchain;

determine when a trigger condition occurs; and

responsive to the trigger condition occurring, return the cryptocurrency to the first digital wallet.

Clause 18. The computer-readable medium of any clause herein, wherein the processing device is further configured to receive a reward after the trigger condition occurs, wherein the reward comprises a certain coin associated with the smart project, a perk associated with the smart project, a convertible note, an executive producer credit associated with the smart project, or some combination thereof.

Clause 19. The computer-readable medium of any clause herein, wherein the processing device is further configured to:

determine when the annual percentage yield in the smart collateral digital wallet satisfies a target value amount; and

responsive to determining the annual percentage yield in the smart collateral digital wallet satisfies the target value amount, perform one or more actions.

Clause 20. The computer-readable medium of any clause herein, wherein the one or more actions comprise:

releasing the cryptocurrency by transmitting at least some of the cryptocurrency to the digital wallet,

transmitting, to a third digital wallet or a bank account, at least some of the annual percentage yield,

transmitting, to the digital wallet, a specialized coin associated with the smart project,

transmitting, to a retirement savings account, at least some of the annual percentage yield, or

some combination thereof.

Clause 21. A computer-implemented method comprising:

deploying a smart contract to an address of a block on a blockchain, wherein the smart contract specifies one or more rules associated with a smart project;

determining when an annual percentage yield in a smart collateral digital wallet satisfies a target value amount, wherein:

the annual percentage yield is generated based on staked cryptocurrency in a second digital wallet separate from the smart collateral digital wallet, and

the staked cryptocurrency is associated with the smart project; and

responsive to determining the annual percentage yield in the smart collateral digital wallet satisfies the target value amount, performing one or more actions.

Clause 22. The computer-implemented method of any clause herein, wherein the one or more actions comprise:

transmitting, to a third digital wallet associated with a user, at least some of the cryptocurrency,

transmitting, to the third digital wallet, a specialized coin associated with the smart project,

creating an executive producer credit associated with the smart project,

transmitting, to an account, at least some of the annual percentage yield, or

some combination thereof.

Clause 23. The method of any clause herein, further comprising:

determining when a trigger condition occurs; and

responsive to the trigger condition occurring, modifying a property of the smart contract.

Clause 24. The computer-implemented method of any clause herein, wherein the trigger condition comprises a change to a value in a market, and wherein the property comprises modifying a period of time associated with the smart contract.

Clause 25. The computer-implemented method of any clause herein, wherein the one or more actions comprise providing a convertible note associated with the smart project.

Clause 26. The computer-implemented method of any clause herein, further comprising:

determining when a value of cryptocurrency reaches a target value amount; and

responsive to determining the value of the cryptocurrency reaches the target value amount:

converting the cryptocurrency to the staked cryptocurrency, and

transmitting one or more receipt coins to a third digital wallet associated with a user who pledged the cryptocurrency to fund the smart project.

Clause 27. The computer-implemented method of any clause herein, further comprising:

determining if a period of time specified in the smart contract has expired; and

responsive to determining the period of time specified in the smart contract has expired, releasing the staked cryptocurrency to one or more digital wallets.

Clause 28. The computer-implemented method of any clause herein, wherein the one or more rules specify when to start accepting the staked cryptocurrency in a staking pool, how long to keep the staking pool open, how much of the annual percentage yield is required to satisfy a target value amount, or some combination thereof.

Clause 29. The computer-implemented method of any clause herein, wherein the one or more actions comprise distributing pro rata to one or more digital wallets associated with users that pledged cryptocurrency to fund the smart project.

Clause 30. The computer-implemented method of any clause herein, wherein the one or more actions comprising providing equity to an account associated with a user who pledged cryptocurrency to fund the smart project.

Clause 31. The computer-implemented method of any clause herein, further comprising the one or more actions comprise converting the staked cryptocurrency into at least one of cryptocurrency and united states dollar coin (USDC).

Clause 32. The computer-implemented method of any clause herein, wherein the one or more actions comprise providing content to a computing device associated with a user who pledged cryptocurrency to fund the smart project.

Clause 33. The computer-implemented method of any clause herein, wherein the target value amount comprises a loan value amount plus an additional percentage value amount, and the one or more actions comprise transmitting the annual percentage yield to an account associated with an underwriter of the loan.

Clause 34. The computer-implemented method of any clause herein, wherein the one or more actions comprises, to comply with one or more federal regulations, declining additional annual percentage yield amounts from being added to the smart collateral wallet.

Clause 35. A system comprising:

a memory device storing instructions; and

a processing device communicatively coupled to the memory device, wherein the processing device executes the instructions to:

deploy a smart contract to an address of a block on a blockchain, wherein the smart contract specifies one or more rules associated with a smart project;

determine when an annual percentage yield in a smart collateral digital wallet satisfies a target value amount, wherein:

the annual percentage yield is generated based on staked cryptocurrency in a second digital wallet separate from the smart collateral digital wallet, and

the staked cryptocurrency is associated with the smart project; and

responsive to determining the annual percentage yield in the smart collateral digital wallet satisfies the target value amount, perform one or more actions.

Clause 36. The system of any clause herein, wherein the one or more actions comprise:

transmitting, to a third digital wallet associated with a user, at least some of the cryptocurrency,

transmitting, to the third digital wallet, a specialized coin associated with the smart project,

creating an executive producer credit associated with the smart project,

transmitting, to an account, at least some of the annual percentage yield, or

some combination thereof.

Clause 37. The system of any clause herein, wherein the processing device is further configured to:

determine when a trigger condition occurs; and

responsive to the trigger condition occurring, modify a property of the smart contract.

Clause 38. The system of any clause herein, wherein the trigger condition comprises a change to a value in a market, and wherein the property comprises modifying a period of time associated with the smart contract.

Clause 39. The system of any clause herein, wherein the one or more actions comprise providing a convertible note associated with the smart project.

Clause 40. A tangible, non-transitory computer-readable medium storing instructions that, when executed, cause a processing device to:

deploy a smart contract to an address of a block on a blockchain, wherein the smart contract specifies one or more rules associated with a smart project;

determine when an annual percentage yield in a smart collateral digital wallet

satisfies a target value amount, wherein:

the annual percentage yield is generated based on staked cryptocurrency in a second digital wallet separate from the smart collateral digital wallet, and

the staked cryptocurrency is associated with the smart project; and

responsive to determining the annual percentage yield in the smart collateral digital wallet satisfies the target value amount, perform one or more actions.

What is claimed is:

1. A computer-implemented method comprising:
receiving, via a user interface, a selection of a smart project to join, wherein the smart project is controlled via a smart contract deployed on a blockchain;
receiving an amount of cryptocurrency to pledge to the smart project for a set period of time based on the smart contract;
transmitting, from a first digital wallet, the amount of cryptocurrency to an address associated with the smart project at a first block on the blockchain;
receiving, based on the amount of cryptocurrency, an annual percentage yield;
transmitting, based on the smart contract, the annual percentage yield to a second block associated with a smart collateral digital wallet on the blockchain;
determining when a trigger condition occurs; and
responsive to the trigger condition occurring, returning the cryptocurrency to the first digital wallet.

2. The computer-implemented method of claim 1, further comprising receiving a reward after the trigger condition occurs, wherein the reward comprises a certain coin associated with the smart project, a perk associated with the smart project, a convertible note, an executive producer credit associated with the smart project, or some combination thereof.

3. The computer-implemented method of claim 1, further comprising:
determining when the annual percentage yield in the smart collateral digital wallet satisfies a target value amount; and
responsive to determining the annual percentage yield in the smart collateral digital wallet satisfies the target value amount, performing one or more actions.

4. The computer-implemented method of claim 3, wherein the one or more actions comprise:
releasing the cryptocurrency by transmitting at least some of the cryptocurrency to the digital wallet,
transmitting, to a third digital wallet or a bank account, at least some of the annual percentage yield,
transmitting, to the digital wallet, a specialized coin associated with the smart project,
transmitting, to a retirement savings account, at least some of the annual percentage yield, or
some combination thereof.

5. The computer-implemented method of claim 1, further comprising:
determining when a condition of a market changes; and
responsive to the condition of the market changing, modifying a property of the smart contract.

6. The computer-implemented method of claim 5, wherein the condition comprises an increase or a decrease in value, and wherein the property comprises modifying a period of time associated with the smart contract.

7. The computer-implemented method of claim 1, further comprising converting the cryptocurrency from a first type of coin to a staked type of coin.

8. The computer-implemented method of claim 1, further comprising using an oracle to check for one or more trigger conditions, wherein:
the trigger condition comprises the set amount of time expiring,
the trigger condition comprises a condition associated with a market occurring,
the trigger condition comprises a certain amount of value accumulating, wherein the value is associated with the cryptocurrency, the annual percentage yield, or some combination thereof, or
some combination thereof.

9. A system comprising:
a memory device storing instructions; and
a processing device communicatively coupled to the memory device, wherein the processing device executes the instructions to:
receive, via a user interface, a selection of a smart project to join, wherein the smart project is controlled via a smart contract deployed on a blockchain;
receive an amount of cryptocurrency to pledge to the smart project for a set period of time based on the smart contract;
transmit, from a first digital wallet, the amount of cryptocurrency to an address associated with the smart project at a first block on the blockchain;
receive, based on the amount of cryptocurrency, an annual percentage yield;
transmit, based on the smart contract, the annual percentage yield to a second block associated with a smart collateral digital wallet on the blockchain;
determine when a trigger condition occurs; and
responsive to the trigger condition occurring, return the cryptocurrency to the first digital wallet.

10. The system of claim 9, wherein the processing device is further configured to receive a reward after the trigger condition occurs, wherein the reward comprises a certain coin associated with the smart project, a perk associated with the smart project, a convertible note, an executive producer credit associated with the smart project, or some combination thereof.

11. The system of claim 9, wherein the processing device is further configured to:
determine when the annual percentage yield in the smart collateral digital wallet satisfies a target value amount; and
responsive to determining the annual percentage yield in the smart collateral digital wallet satisfies the target value amount, perform one or more actions.

12. The system of claim 11, wherein the one or more actions comprise:
releasing the cryptocurrency by transmitting at least some of the cryptocurrency to the digital wallet,
transmitting, to a third digital wallet or a bank account, at least some of the annual percentage yield,
transmitting, to the digital wallet, a specialized coin associated with the smart project,
transmitting, to a retirement savings account, at least some of the annual percentage yield, or
some combination thereof.

13. The system of claim 9, wherein the processing device is further configured to:
determine when a condition of a market changes; and
responsive to the condition of the market changing, modify a property of the smart contract.

14. The system of claim 13, wherein the condition comprises an increase or a decrease in value, and wherein the property comprises modifying a period of time associated with the smart contract.

15. The system of claim 9, wherein the processing device is further configured to convert the cryptocurrency from a first type of coin to a staked type of coin.

16. The system of claim 9, wherein the processing device is further configured to use an oracle to check for one or more trigger conditions, wherein:
the trigger condition comprises the set amount of time expiring,
the trigger condition comprises a condition associated with a market occurring,
the trigger condition comprises a certain amount of value accumulating, wherein the value is associated with the cryptocurrency, the annual percentage yield, or some combination thereof, or
some combination thereof.

17. A tangible, non-transitory computer-readable medium storing instructions that, when executed, cause a processing device to:
receive, via a user interface, a selection of a smart project to join, wherein the smart project is controlled via a smart contract deployed on a blockchain;
receive an amount of cryptocurrency to pledge to the smart project for a set period of time based on the smart contract;
transmit, from a first digital wallet, the amount of cryptocurrency to an address associated with the smart project at a first block on the blockchain;
receive, based on the amount of cryptocurrency, an annual percentage yield;
transmit, based on the smart contract, the annual percentage yield to a second block associated with a smart collateral digital wallet on the blockchain;
determine when a trigger condition occurs; and
responsive to the trigger condition occurring, return the cryptocurrency to the first digital wallet.

18. The computer-readable medium of claim 17, wherein the processing device is further configured to receive a reward after the trigger condition occurs, wherein the reward comprises a certain coin associated with the smart project, a perk associated with the smart project, a convertible note, an executive producer credit associated with the smart project, or some combination thereof.

19. The computer-readable medium of claim 17, wherein the processing device is further configured to:
determine when the annual percentage yield in the smart collateral digital wallet satisfies a target value amount; and
responsive to determining the annual percentage yield in the smart collateral digital wallet satisfies the target value amount, perform one or more actions.

20. The computer-readable medium of claim 19, wherein the one or more actions comprise:
releasing the cryptocurrency by transmitting at least some of the cryptocurrency to the digital wallet,
transmitting, to a third digital wallet or a bank account, at least some of the annual percentage yield,
transmitting, to the digital wallet, a specialized coin associated with the smart project,
transmitting, to a retirement savings account, at least some of the annual percentage yield, or
some combination thereof.
